(19) United States
(12) Patent Application Publication
(10) Pub. No.: US 2025/0071866 A1
(43) Pub. Date: Feb. 27, 2025

(54) DOMESTIC APPLIANCE AND PULL-OUT GUIDE FOR A DOMESTIC APPLIANCE

(71) Applicant: PAUL HETTICH GMBH & CO. KG, Kirchlengern (DE)

(72) Inventors: Peter JÄHRLING, Bünde (DE); Andreas LÖH, Kirchlengern (DE); Johann-Sebastian LESSMANN, Löhne (DE); Thomas BECKMANN, Paderborn-Sande (DE)

(21) Appl. No.: 18/729,580

(22) PCT Filed: Jan. 17, 2023
(86) PCT No.: PCT/EP2023/051014

§ 371 Date: Jul. 17, 2024

(30) Foreign Application Priority Data
Jan. 18, 2022 (DE) 10 2022 101 098.8

(51) Int. Cl. H05B 6/64; F24C 15/16

(52) U.S. Cl. CPC H05B 6/6408; F24C 15/168

(57) ABSTRACT

A pull-out guide for a domestic appliance with a microwave cooking function. The pull-out guide includes a rack rail and a metal guide rail movable relative thereto as a shelf for a cooking product carrier. A stopper is disposed in a front region of the guide rail as seen in the pull-out direction, which stopper has an abutment element for the cooking product carrier projecting forwards and upwards over the guide rail. The stopper is at least partially manufactured from an electrically insulating material.

### BACKGROUND AND SUMMARY OF THE INVENTION

Exemplary embodiments of the invention relate to a pull-out guide for a domestic appliance with microwave cooking function, which has a cabinet rail and at least one metallic running rail, which can be moved relative thereto, for depositing a food carrier, wherein a stopper is arranged in a front region of the running rail as seen in the pull-out direction, which stopper has a contact element for the food carrier projecting forwards and upwards over the running rail. Exemplary embodiments of the invention also relate to a domestic appliance with microwave cooking function with such a pull-out guide.

In various types of domestic appliances, pull-out guides have become established on which removable carriers can be placed, which can be conveniently pushed into the domestic appliance or extended and removed more easily through the pull-out guide. The stopper arranged at the front end can be designed with a molded-on contact element or with a separate contact element and is sometimes used to cover the running rail for visual reasons and to avoid sharp edges at the front that could cause injury. The contact element also prevents the carrier from slipping off the running rail. In the case of cooking appliances, such carriers are, for example, food carriers such as baking trays or grids.

As a rule, both the running rails of the pull-out guides and the food carriers are made of a metallic material. The arrangement of metal on metal is electrically conductive and also conducts heat well, which can be problematic in cooking appliances and especially in microwave ovens. Electrical contact between the pull-out guide and a generally conductive coated front panel of a microwave oven is also unfavorable with regard to possible sparking.

To prevent electrical contact in microwave cooking appliances, it is known to provide the food carriers and/or the running rail of the pull-out guide with an electrically insulating coating, for example a ceramic coating. However, such a coating is susceptible to scratching. A pull-out guide for a cooking appliance that is at least partially coated with PTFE (polytetrafluoroethylene) is known from the publication DE 102 11 470 A1. The pull-out guide can be cleaned more easily thanks to the coating and there are advantages with regard to smooth running of the pull-out system, as this coating also dampens noise.

However, both the PTFE coating mentioned and a ceramic coating are only suitable to a limited extent for electrically insulating the pull-out guide from a door or the front panel of a microwave oven in such a way that sparkovers are reliably prevented.

Exemplary embodiments of the present invention are directed to a pull-out guide for a domestic appliance with a microwave cooking function and a domestic appliance equipped therewith, in which good insulation between the running rail and the door or other front of a microwave cooking appliance can be achieved without great effort and permanently.

A pull-out guide of the type mentioned at the beginning of the invention is characterized in that the stopper is at least partially made from an electrically insulating material. Instead of or in addition to a coating of the running rail, effective protection against flashovers from the running rail to the front of the microwave cooking appliance is achieved by the stopper, in particular by the contact element, which covers the running rail at the front and preferably also covers it on all sides and which is at least partially made of an electrically insulating material. The resulting distance between the metal running rail and the front prevents sparkover. This is particularly effective if the contact element projects beyond the running rail on all sides. This is already the case at the top due to its function as a stop for the food carrier, while a slight protrusion to the left, right and bottom is an effective means of preventing flashovers.

The electrically insulating materials listed below can be used, among others: Ceramics, high-temperature-resistant thermoplastics, in particular from the polyether ketone family (e.g. polyether ether ketone-PEEK) and/or elastomers, in particular from the polysiloxane or thermoset family.

In a preferred design, at least the contact element is made of the electrically insulating material. As it is part of the stopper, which is arranged at the front of the running rail, it can be made of an insulating material and still be mounted on the running rail in a simple manner. The stopper, which is inserted into the running rail or surrounds it in sections, can be used to create a frictional or form-fit connection between the stopper and the running rail, through which the contact element is attached to the running rail. The material of the stopper or the contact element can also be thermally insulating and/or shock-absorbing in order to protect the front of the domestic appliance mechanically and with regard to local thermal stresses.

It should be noted that a stopper within the meaning of the application is an element that can be inserted into the running rail from the front or from one side or that can be pushed onto the running rail from the front or from one side. In one design of the pull-out guide, the stopper then comprises an insertion body which can be inserted into the front end of the running rail. In a further design, a base body is provided instead of the insertion body, which at least partially comprises a front section of the running rail. The base body can be C-shaped, for example, in order to grip around the running rail and, optionally, to be clipped on from the side.

In both cases, attachment to the running rail can be by clamping, latching, and/or material bonding, in particular by thermal joining. In the embodiment with the insertion body, a form-fit fastening can additionally or alternatively be achieved by forming, in particular countersinking, a section of the running rail in the front area after the insertion body has been inserted into the running rail. For example, the running rail can have a punched-out web that is pressed in accordingly for reshaping and engages behind an edge of the insertion body. In the embodiment with the encompassing base body, this can have a projection for additional fastening, which engages in a hole or recess in the running rail.

The stopper can be designed in one piece or also in at least two parts, wherein in the latter case at least the contact element is not designed integrally with the insertion body or the base body. The two-part or multi-part design offers the possibility that the contact element is made of a different material than the insertion body or the base body. For example, the contact element can be made of ceramic, while the insertion body is made of plastic. Due to the elasticity of the plastic, a good frictional connection can be achieved between the insertion body and the running rail, i.e., the stopper can be securely fastened in the running rail. The ceramic material of the contact element offers good electrical insulation and provides particularly good protection against flashovers. However, it is also conceivable to manufacture the insertion body from the electrically insulating material, in particular from a ceramic or a PEEK, and the contact element from a different material.

In an advantageous design of the pull-out guide, the stopper also has a support section for the food carrier that is aligned parallel to the pull-out direction and protrudes upwards over the running rail. As a result, the stopper serves as a support for the food carrier and can insulate the food carrier electrically from the running rail. An upwardly projecting guide pin for the food carrier can also be arranged in the region of the support section of the stopper. If the guide pin engages in a corresponding recess or indentation in the food carrier, the latter is also fixed laterally and/or in the pull-out direction.

In a further advantageous design, the pull-out guide has a stop element which is mounted on the running rail in a rear area as seen in the pull-out direction and has a stop for the food carrier projecting upwards over the running rail. Preferably, the stop element has a further support section for the food carrier that is aligned parallel to the pull-out direction and projects upwards over the running rail. As a result, the food carrier rests on the support section of the stopper in the front area and on the further support section of the stop element in the rear area. If the support section of the stopper and the other support section have the same thickness, the food carrier is aligned parallel to the running rail. Alternatively, it is possible to form the two support sections in defined and optionally significantly different thicknesses. In this case, an inclination of the pull-out guide can also be provided with a flat alignment of the food carrier, which, for example, prevents or encourages the pull-out guide to run in/out on its own without tilting the food carrier. Preferably, the stop element as a whole or at least the further support section is made of an insulating material, so that the food carrier is then completely electrically insulated from the running rail.

Furthermore, the stop can be formed by a protrusion with which the stop element is placed on a stop bolt that is arranged on the running rail. Such stop bolts are often fitted as standard to running rails and can then be used advantageously as a fastening option for the stop element. A damping cap made of a material that is softer than the material of the protrusion can also be placed on the protrusion. This results in a noise-damped stop and soft positioning of the food carrier.

In a further advantageous design, the running rail of the pull-out guide has an essentially U-shaped profile with two legs, wherein a contact element is arranged on or in the stopper, which electrically contacts two end sections of the legs of the running rail with each other. This is based on the realization that microwaves can penetrate the U-shaped track from the front through the stopper if it is made of an insulating material. Inside the running rail, the microwaves are then transmitted by reflection until they hit an obstacle, e.g., a rolling element cage. There they emit their energy, which leads to unnecessary and undesirable heating of the obstacle and thus of the pull-out guide. The electrical contacting of the end sections of the running rail by the contact element effectively prevents the microwaves from penetrating into the volume area enclosed by the running rail.

A domestic appliance with microwave cooking function according to the invention is characterized in that it has at least one such pull-out guide. This results in the advantages mentioned in connection with the pull-out guide.

### BRIEF DESCRIPTION OF THE DRAWING FIGURES

The invention is explained in more detail below with reference to exemplary embodiments with the aid of figures, wherein:

FIG. 1a shows an isometric representation of a pull-out guide with a front stopper and a rear stop element;

FIG. 1b shows the pull-out guide in FIG. 1a with the stopper or stop element removed;

FIG. 1c shows a representation of the pull-out guide in FIGS. 1a, b with the baking tray in place;

FIG. 2a shows an isometric representation of a pull-out guide in a further exemplary embodiment with dismantled stopper or stop element and a section of a baking tray to be placed on top;

FIG. 2b shows pull-out guides as shown in FIG. 2a with baking tray in place;

FIG. 2c shows a detailed illustration from FIG. 2b;

FIGS. 3a, b show a pull-out guide in a further exemplary embodiment with dismantled stopper or stop element (FIG. 3a) and assembled with the baking tray in place (FIG. 3b);

FIGS. 4a, b show a pull-out guide in a further exemplary embodiment with dismantled stopper or stop element (FIG. 4a) and assembled with the baking tray in place (FIG. 4b);

FIGS. 5a, b show a pull-out guide in a further exemplary embodiment in an isometric overall view (FIG. 5a) and a detailed view of its front section (FIG. 5b);

FIGS. 6a, b show a pull-out guide in a further exemplary embodiment without (FIG. 6a) and with the baking tray in place (FIG. 6b);

FIG. 6c shows two isometric detailed views of the stopper of the pull-out guide of FIGS. 6a, b;

FIGS. 7a, b show representations of a front section of a pull-out guide in a further exemplary embodiment with the stopper dismantled (FIG. 7a) or inserted (FIG. 7b);

FIGS. 8a, b show representations of a front section of a pull-out guide in a further exemplary embodiment with the stopper dismantled (FIG. 8a) or inserted (FIG. 8b);

FIGS. 9a-c show representations of a front section of a pull-out guide in a further exemplary embodiment with the stopper dismantled (FIGS. 9a, b) or inserted (FIG. 9c);

FIGS. 10a-c show representations of a front section of a pull-out guide in a further exemplary embodiment with the stopper dismantled (FIGS. 10a, b) or inserted (FIG. 10c);

FIGS. 11a-c show representations of a front section of a pull-out guide in a further exemplary embodiment with the stopper dismantled (FIGS. 11a, b) or inserted (FIG. 11c);

FIGS. 12a-c show representations of a front section of a pull-out guide in a further exemplary embodiment with the stopper dismantled (FIGS. 12a, b) or inserted (FIG. 12c);

FIGS. 13a, b show a representation analogous to FIGS. 12b and 12c from a different angle;

FIGS. 14a, b show representations of a front section of a pull-out guide in a further exemplary embodiment with the stopper dismantled (FIG. 14a) or inserted (FIG. 14b);

FIGS. 15a-c show various representations of the stopper (FIGS. 15a, b) or the running rail with inserted stopper (FIG. 15c) as shown in FIGS. 14a, b;

FIGS. 16a, b show representations of a front section of a pull-out guide in a further exemplary embodiment with the stopper dismantled (FIG. 16a) or inserted (FIG. 16b); and

FIGS. 17a-c show various representations of the stopper (FIGS. 17a, b) or the running rail with inserted stopper (FIG. 17c) as shown in FIGS. 16a, b.

In all figures, the same reference signs indicate elements that are identical or have the same effect. For reasons of clarity, not all elements are marked with reference signs in all figures. If relative terms such as “left” or “right” are used in the description, these refer to the figures described. Only the terms “front”, “rear”, “top” and “bottom” refer to the natural orientation of the pull-out guide in operation, in which a food carrier rests on top of the pull-out guide and in which the front end of the pull-out guide faces towards a user located in front of the domestic appliance in which the pull-out guide is used.

### DETAILED DESCRIPTION

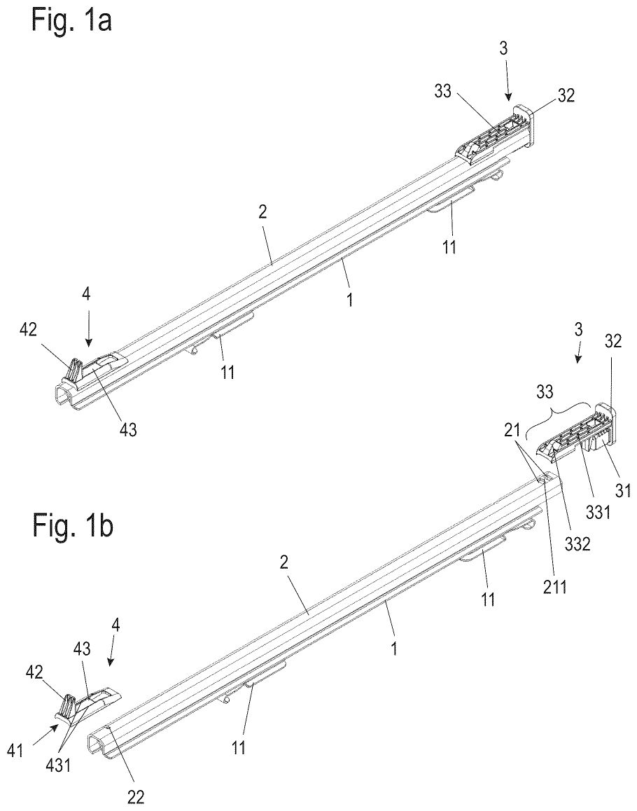

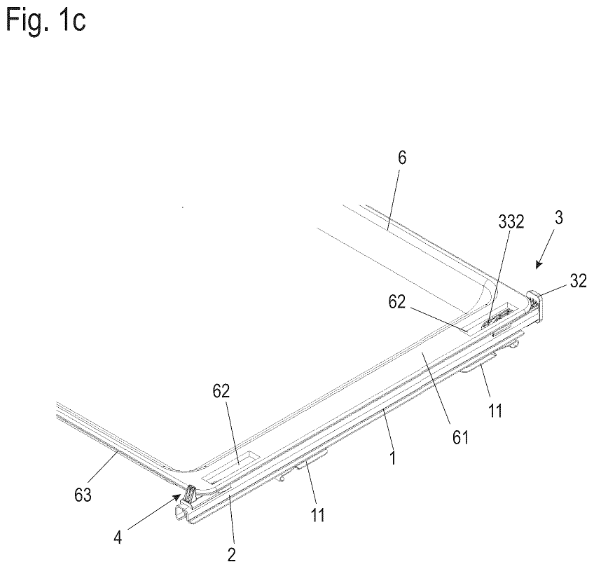

FIGS. 1a-1c show a first exemplary embodiment of a pull-out guide according to the application.

The pull-out guide has a fixed cabinet rail 1 that can be fixed in or on a domestic appliance using mounting elements, here exemplified by mounting clamps 11. The pull-out guide 1 is suitable for a cooking appliance with a food carrier, e.g. a baking tray 6 (see FIG. 1c). In this case, the mounting clamps 11 can be attached to a side grid, which is typically located in the cooking chamber of the cooking appliance.

The pull-out guide comprises a running rail 2, which is mounted so that it can move relative to the cabinet rail 1. In the example shown, the cabinet rail 1 as well as the running rail 2 and the mounting clamps 11 are made of metal, e.g., punched and bent sheet metal. Between cabinet rail 1 and running rail 2 there is an arrangement of rolling elements, not visible here, which allow the running rail 2 to move easily in relation to the cabinet rail 1. Further components, such as additional running rails or center rails, can also be arranged between the cabinet rail 1 and the running rail 2 to enable an extension.

FIG. 1a shows the pull-out guide in an assembled state with a stopper 3 in the front area of the running rail 2 and a stop element 4 in the rear area of the running rail 2. In FIG. 1b, the stopper 3 and the stop element 4 are shown separately from the pull-out guide. Finally, FIG. 1c shows the pull-out guide in the assembled state with a baking tray 6 partially placed on top.

The stopper 3 is attached to a front end of the running rail 2. In this exemplary embodiment, it has an insertion body 31 for this purpose, which is pushed into the essentially U-shaped profile of the running rail 2. After the insertion body 31 has been pushed in, the stopper 3 rests against the front end of the running rail 2 with a contact element 32 projecting laterally and in particular upwards beyond the insertion body 31. The contact element 32 prevents the placed baking tray 6 from slipping forwards off the running rail 2.

In contrast to the running rail 2, which is made of metal, the stopper 3 and in particular the contact element 32 is made of an electrically insulating material, for example the plastic PEEK (polyether ether ketone). As a result, the contact element 32 of the stopper 3 separates the metal of the running rail 2 from a door, flap or other front of the microwave oven. This prevents a possible sparkover between the front end of the running rail 2 and the front. Microwave ovens often use a door or flap with a front panel that is provided with conductive elements, for example with a conductive coating or wires in the glass. The material of the contact element 32 or the stopper 3 can also be shock-absorbing and/or thermally insulating and thus protect the door or flap mechanically and with regard to local thermal loads.

In this exemplary embodiment, the stopper 3 is formed in one piece, for example made of plastic, e.g., the aforementioned PEEK, in an injection molding process.

In the front area of the running rail 2, two recesses 21 are made in the material of the running rail 2, into which, for example, latching elements of the insertion body 31 engage, so that the stopper 3 is fixed to the running rail 2 after insertion. However, it is also possible to secure the inserted stopper 3 to the running rail 2 by countersinking a web 211 remaining between the two recesses 21.

A further special feature of the stopper 3 of this exemplary embodiment is a support section 33, which, starting from the contact element 32, rests on the running rail 2 when the stopper 3 is inserted. Towards the running rail 2, the support section 33 is adapted to the shape of the running rail and embraces it at least partially (in the present case in the area of lateral chamfers of the running rail 2) in order to be fixed laterally on the running rail 2 and to achieve a larger support surface for the baking tray 6. Towards the top, the support section 33 is provided with longitudinal webs 331. In addition, a guide pin 332 projects in height beyond the longitudinal webs 331. The support section 33, which is also made of the insulating material, electrically insulates the baking tray 6 from the running rail 2, which prevents flashovers between these two parts.

A stop element 4 is placed on the rear end of the running rail 2, which provides an upwardly projecting stop 42 and a further support section 43. The stop element 4 is provided with a hole 22 for fastening it to the running rail 2. The stop element 4 has a mounting means 41, for example a pin, hook, or lug (not visible here), which engages in the hole 22 and which can be provided with latching means so that the stop element 4 is held on the running rail 2. Instead of a pin, a screw connection can also be used to secure the stop element or a rivet that engages in the hole 22. In this case, the screw head or rivet head is housed in a recess in the stop element 4 in order to be at a distance from the baking tray 6, so that the insulation between the baking tray 6 and the running rail 2 is maintained.

A profiling of the underside of the stop element 4, which is adapted to the shape of the running rail 2, also serves to secure the stop element 4 to the running rail 2. This profiling, in particular areas that partially enclose the sides of the running rail 2, is also to be understood as a mounting means 41. The further support section 43 is provided with longitudinal webs 431 in a similar way to the support section 33 of the stopper 3.

As can be seen in FIG. 1c, the baking tray 6 rests with an edge 61 on the support sections 33 and 43 and in particular on the longitudinal webs 331 and 431. In contrast to the running rail 2, which is made of metal, the stopper 3 and the stop element 4 are made of an electrically insulating material, for example the aforementioned plastic PEEK, so that the supported baking tray 6 is completely electrically insulated from the metal of the pull-out guide.

The stopper 3 and the stop element 4 can also have a noise-damping effect. In order to optimize noise damping, parts of the stopper 3 and/or the stop element 4 can also be made of a softer component than the base material. For example, the longitudinal webs 331 or 431 can be made of a molded-on or bonded-on, softer silicone material.

The baking tray 6 has apertures 62 in the edge 61, wherein the guide pin 332 of the stopper 3 engages in the front of the apertures 62 and thus positions the baking tray 6 during placement and, in particular, fixes it in a lateral direction. In the rear area of the baking tray 6, it rests with an outer edge 63 against the stop 42 of the stop element 4. Alternatively, however, the food carrier can also be positioned on the elements of the stopper 3 and/or the stop element 4 on the running rail 2 by means of a flange around the edge of the food carrier, in this case the baking tray 6, or a wire running around a grid-shaped food carrier.

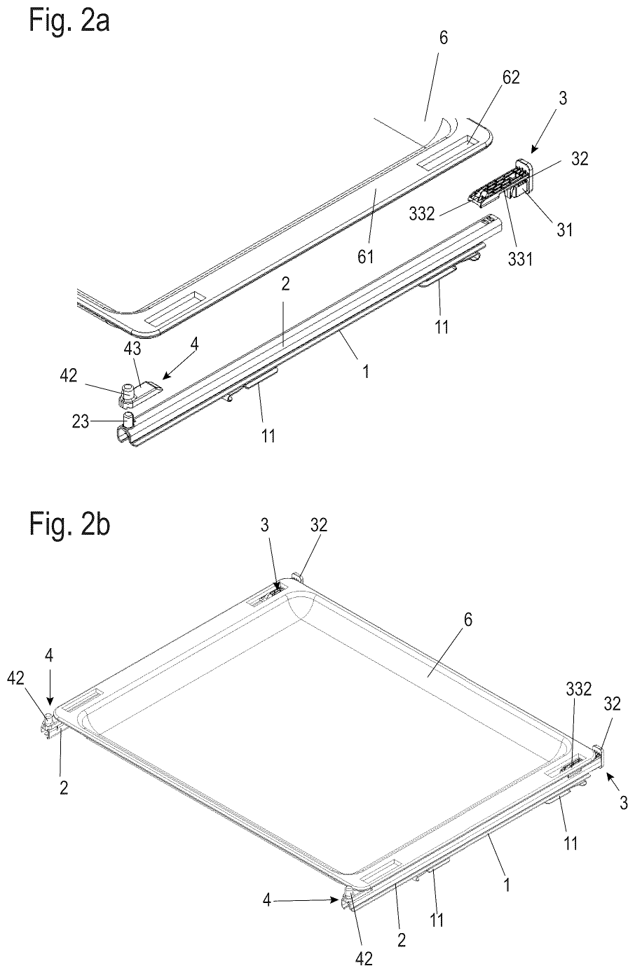

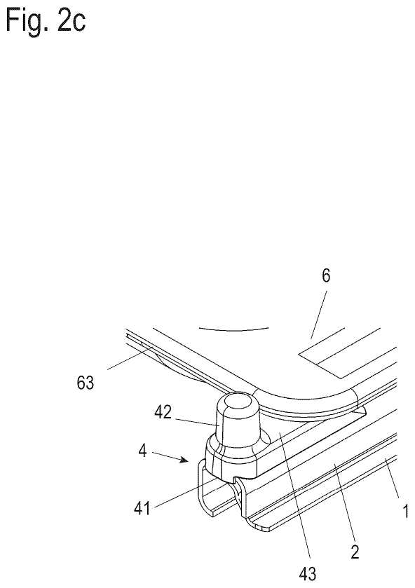

FIGS. 2a-c show a further exemplary embodiment of a pull-out guide according to the application. This pull-out guide also has a stopper 3 and a stop element 4. FIG. 2a shows the pull-out guide with the dismantled stopper 3 and stop element 4 and a baking tray 6 in place. FIG. 2b shows the baking tray 6 placed on the two pull-out guides shown here. FIG. 2c is a detailed illustration of the rear support area of the baking tray 6 on the pull-out guide.

The structure of the pull-out guide of this second exemplary embodiment with cabinet rail 1 and running rail 2 is basically comparable to that of the first exemplary embodiment. In contrast to the first exemplary embodiment, there is no hole at the rear end of the running rail 2 for fastening the stop element 4, but a metal stop bolt 23 is fastened, in particular welded, to the running rail 2.

The stopper 3 fixed at the front end of the running rail 2 corresponds to that of the first exemplary embodiment, the description of which is hereby referred to. The stop element 4, which is inserted in the rear area of the running rail 2, differs from that of the first exemplary embodiment. It also has a support section 43, on which the baking tray 6 is positioned with its edge 61. Behind the support section 43, a stop 42 is formed, which here has the shape of a hollow cylindrical protrusion that forms a cap with which the stop element 4 is placed on the stop bolt 23 of the running rail 2. The stop element 4 can be attached to the stop bolt 23 by form-fit or frictional connection. In addition, at the rear end of the stop element 4, a latching element engaging around the edge of the running rail 2 can be formed as a mounting means 41.

Like the stopper 3 and the stop element 4 of the first embodiment, the stop element 4 of the second embodiment can be made of an insulating material, for example PEEK. It is also conceivable that a softer material, for example silicone, is used in the area of the support section 43. As in the first exemplary embodiment, the support of the baking tray 6 on the support section 33 or 43 of the stopper 3 or stop element 4 provides electrical, or optionally also thermal or noise-damping insulation between the baking tray 6 and the running rail 2 and, through the contact element 32, between the running rail 2 and a door, flap or other front of the domestic appliance.

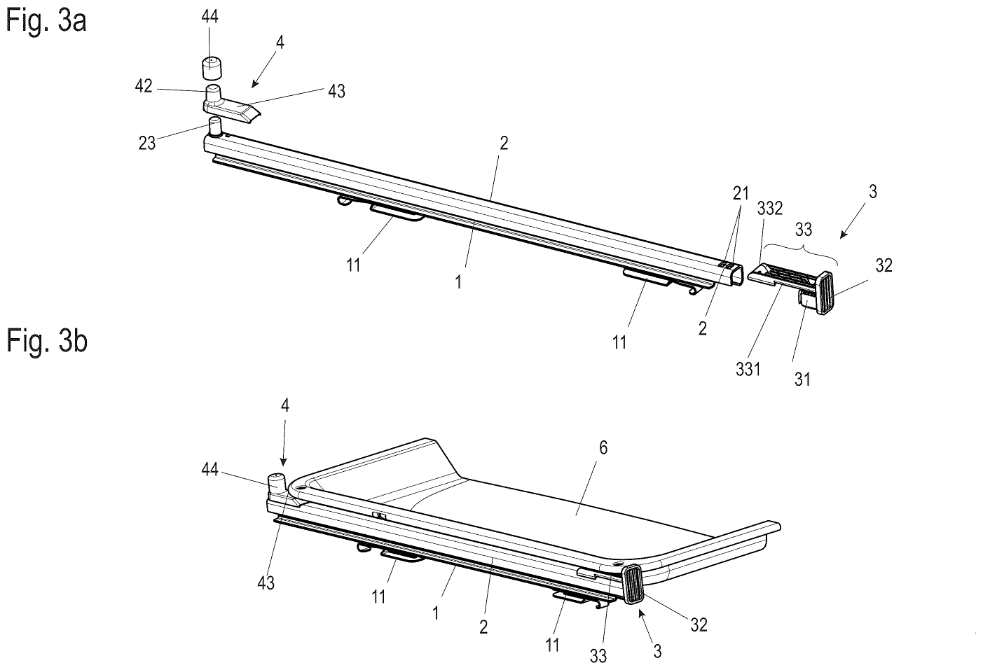

FIGS. 3a and 3b show a further development of the second exemplary embodiment. The basic structure of the pull-out guide corresponds to that of the second exemplary embodiment shown in FIGS. 2a-c. FIG. 3a shows the pull-out guide with the stopper 3 removed and the stop element 4 lifted off. FIG. 3b shows the assembled pull-out guide with a baking tray 6 partially placed on top.

In this third exemplary embodiment, the stopper 3 again corresponds to one of the exemplary embodiments described above. The stop element 4 is constructed in a similar way to that of the second exemplary embodiment. As before, the stop element 4 is provided with a hollow cylindrical protrusion that forms a cap with which the stop element 4 is fitted onto the stop bolt 23 of the running rail 2. In addition, a damping cap 44 is provided, which is placed on the stop 42 of the stop element 4. This damping cap 44 is preferably made of a softer material, for example a silicone, so that an impact of the baking tray 6 against the stop element 4 is damped even more effectively.

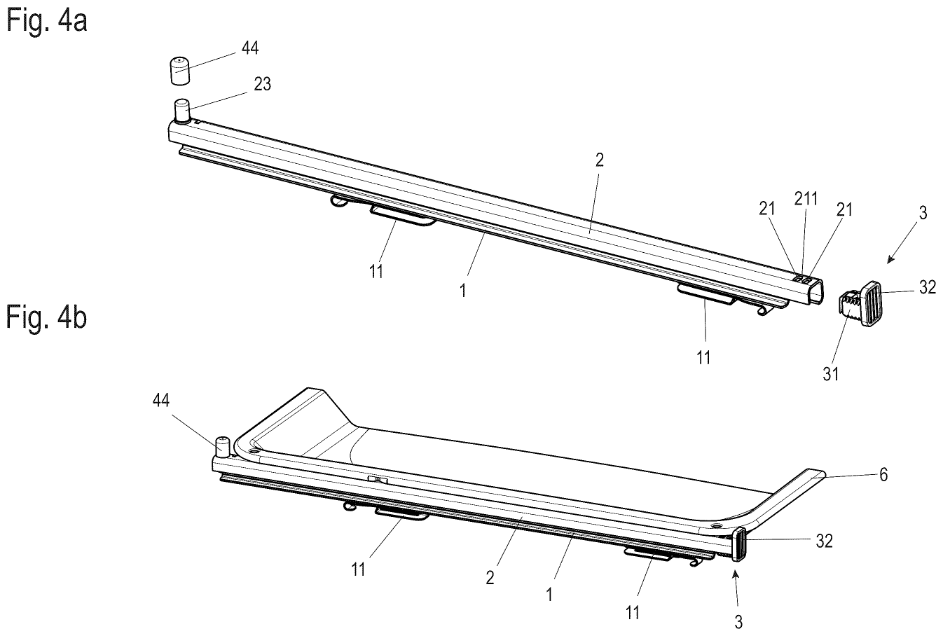

FIGS. 4a and 4b show a further exemplary embodiment of a pull-out guide according to the application in the same way as FIGS. 3a and 3b.

The basic structure of the pull-out guide corresponds to that of the second and third exemplary embodiments, i.e., a stop bolt 23 is attached to the running rail 2.

A damping cap 44 is fitted directly onto this stop bolt 23. This has a similar structure to that of the third exemplary embodiment, only with a reduced internal diameter, so that it can be fixed directly onto the stop bolt 23 with a form-fit and frictional connection. In this way, no insulation is achieved along the edge 61 of the baking tray 6, but damping of the impact of the edge 63 of the baking tray 6 on the stop bolt 23 is achieved.

Unlike in the previously shown exemplary embodiments, a stopper 3 is arranged in the front area of the running rail 2, which provides a contact element 32, but no support for the baking tray 5. This stopper 3 therefore also does not provide any insulation between the running rail 2 and the baking tray 6, but does provide insulation between the running rail 2 and the front of the domestic appliance, as in the previous exemplary embodiments.

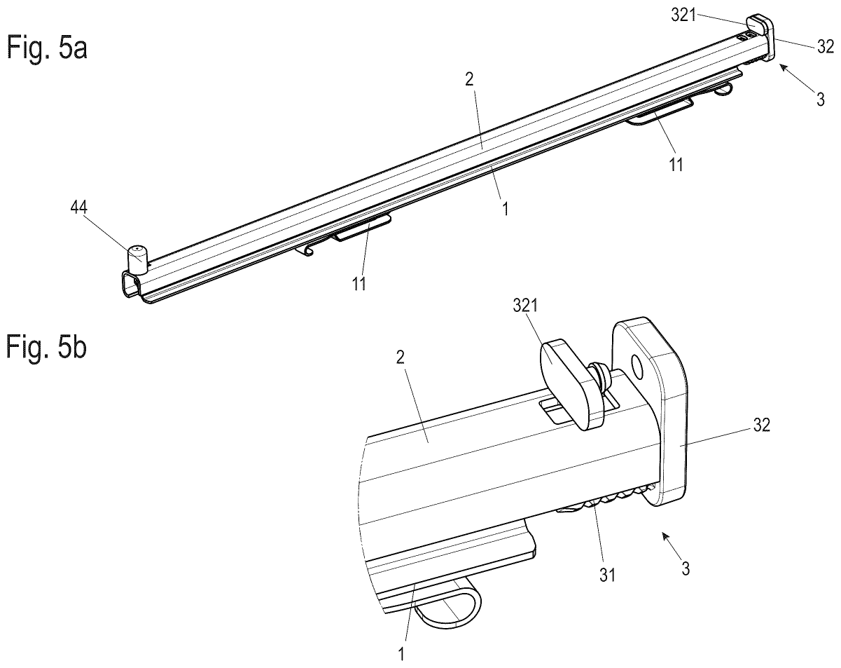

FIGS. 5a and 5b show a further development of the fourth exemplary embodiment. The basic structure of the pull-out guide is the same as that of the fourth exemplary embodiment shown in FIGS. 4a and 4b. Likewise, as in the fourth exemplary embodiment, a damping cap 44 is placed on a stop bolt 23 of the running rail 2. In this way, a rear stop of a food carrier (not shown here) is damped against the running rail 2.

The stopper 3 is modified compared to the stopper from the fourth exemplary embodiment in that a damping element 321 is arranged on the side of the contact element 32 facing the running rail 2 in its section projecting at the top. The damping element 321 essentially fills the protruding area of the contact element 32 and is connected to it via an insertion pin. For this purpose, the contact element 32 has a hole for receiving the insertion pin. The damping element 321 also dampens the impact of the edge 63 of the baking tray 6 in the front area of the running rail 2. A soft plastic, in particular a silicone, can be used as the material of the damping element 321. As an alternative fastening, the damping element 321 can also be fixed to the contact element 32 with a material connection.

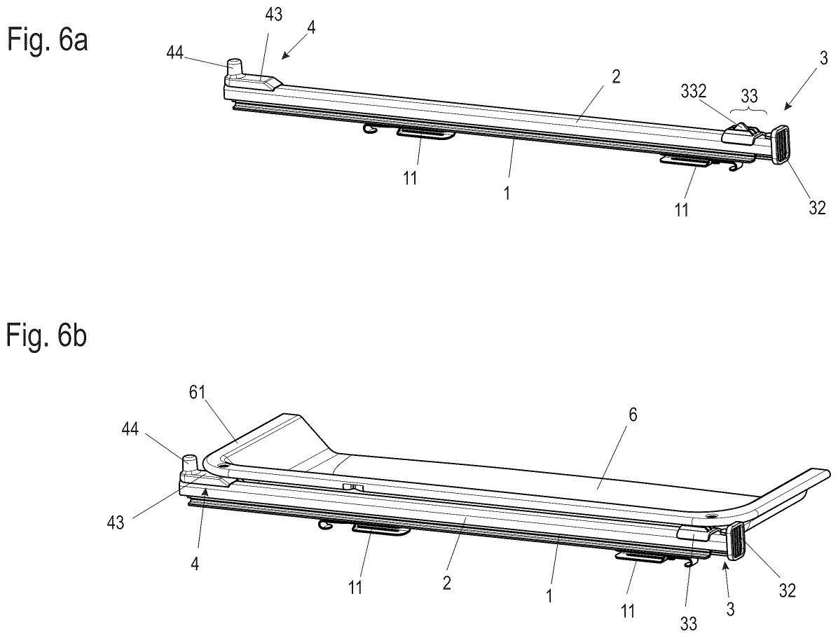

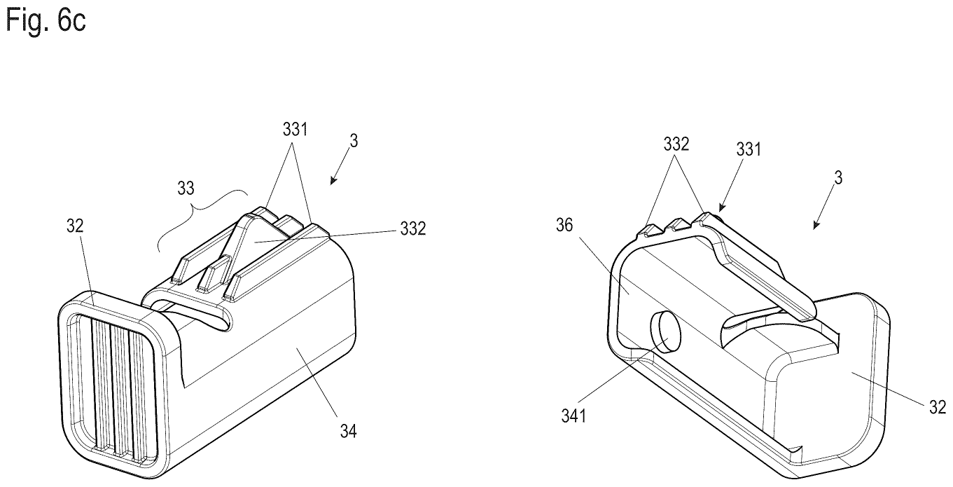

FIGS. 6a-c show a further exemplary embodiment of a pull-out guide according to the application. FIGS. 6a and 6b show the assembled pull-out guide in an isometric overall view, once without the baking tray (FIG. 6a) and once with the baking tray 6 in place (FIG. 6b).

The basic structure of the pull-out guide with cabinet rail 1 and running rail 2 corresponds to the structure of the pull-out guides shown above.

A stop element 4, which is already shown in this configuration in the third exemplary embodiment in FIGS. 3a and 3b, is used in the rear area of the running rail 2.

The exemplary embodiment in FIGS. 6a-c shows an alternative design of a stopper 3 for use with a pull-out guide. In FIG. 6c, the stopper 3 is shown separately in two isometric views from different angles.

Unlike the stopper 3 described in the previous exemplary embodiments, this stopper 3 according to FIGS. 6a-c is not inserted into the front end of the running rail 2, but is placed on the front end. Like the examples described above, this stopper 3 is manufactured in one piece from an insulating material, e.g., PEEK or another suitable plastic. As in the examples described above, the stopper 3 provides electrical insulation between the running rail 2 and a door, flap or other front of the microwave oven and between the running rail 2 and the baking tray 6 placed on top.

The stopper 3 has an approximately C-shaped base body 34, which at least partially surrounds the running rail 2. The base body 34 can be made of an elastic material to the extent that it can also be clipped around the running rail 2 from the side.

A projection 341 is arranged on a laterally located inner side of the base body 34, which engages in a corresponding recess or hole on the running rail 2, whereby the stopper 3 is fixed in the longitudinal direction. However, it is also possible to dispense with the form-fit fixing and the projection 341 provided for this purpose if the stopper 3 and the running rail 2 are adapted to each other in such a way that the stopper 3 is fixed by frictional engagement.

On the outer upper side of the base body 34, a support section 33 is again formed for an edge of a placed baking tray. Similar to the stopper 3 shown in FIGS. 1a-3b, longitudinal webs 331 and a guide pin 332 are formed, which positions and laterally fixes the placed baking tray.

In an alternative design of the exemplary embodiment shown in FIGS. 6a-c, it may be provided that the stopper 3 is formed by two separate parts, both parts having a base body 34 for attachment to the running rail 2. The front of the parts comprises the contact element 32 and the rear of the parts comprises the support section 33.

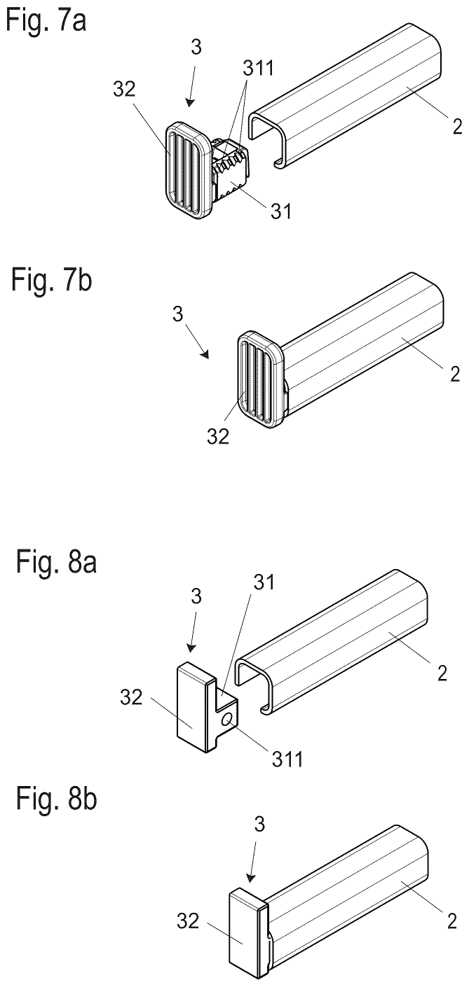

FIGS. 7a-11c show further exemplary embodiments of stoppers 3 that can be inserted into a front end of a running rail 2 of a pull-out guide and which insulate this front end of the running rail 2 from a door or flap of a domestic appliance with microwave cooking function. In the figures mentioned, only a front section of the running rail 2 of the pull-out guide is shown. The pull-out guide can, for example, be designed in the same way as the pull-out guides shown in the previously described exemplary embodiments.

FIGS. 7a, b and 8a, b show two further examples of integral stoppers 3. FIGS. 7a and 8a show the stopper 3 before insertion into the running rail 2 and FIGS. 7b and 8b show the stopper 3 inserted into the running rail 2.

In the exemplary embodiment shown in FIGS. 7a, b, the stopper 3 is similar to the stopper shown in FIGS. 4a, b. In contrast to the exemplary embodiment shown there, a purely clamping attachment of the stopper 3 in the front end of the running rail 2 is provided here. For this purpose, the insertion body 31 of the stopper 3 has elevations 311, here in the form of corrugations, along the four longitudinal edges of the insertion body 31.

In the exemplary embodiment of FIGS. 8a, b, instead of the corrugation, an elevation 311 in the form of a curved projection is arranged on one or both sides of the insertion body 31.

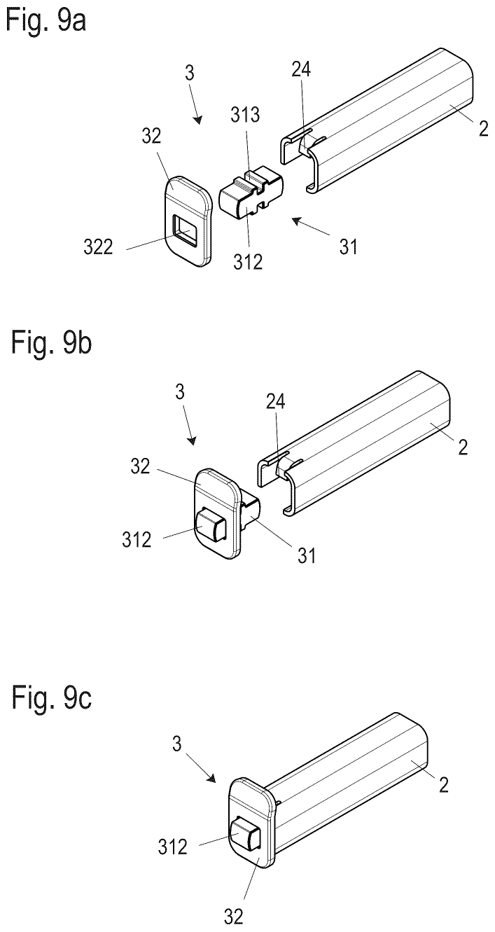

The stopper 3 shown in the exemplary embodiment in FIGS. 9a-c is constructed in two parts, unlike those described above, and has an insertion body 31 which is connected to a contact element 32. In contrast to the previously shown exemplary embodiments, the insertion body 31 and the contact element 32 are therefore not integrally formed with each other.

FIG. 9a shows an exploded view of the insertion body 31 before it is inserted into the front end of the running rail 2 and the contact element 32 before it is connected to the insertion body 31. FIG. 9b shows the contact element 32 attached to the insertion body, although the stopper 3 thus formed is not yet inserted into the running rail 2. Finally, FIG. 9c shows the stopper 3 inserted into the front end of the running rail 2.

To connect the contact element 32 to the insertion body 31, the contact element 32 has a rectangular opening 322 in this exemplary embodiment, into which a pin 312 of the insertion body 31 is inserted when it is attached together. This can be done, for example, in such a way that the contact element 32 and the insertion body 31 are connected to each other in a clamped manner.

One advantage of the two-part structure of the stopper 3 is the possibility of using different materials for the insertion body 31 and the contact element 32. For example, the contact element 32 can be made of a ceramic material, which provides good insulation and shielding with regard to flashover prevention. The insertion body 31 can be made of a plastic material that is elastic in contrast to ceramic. Due to the elasticity of the plastic, a good frictional connection can be achieved between the insertion body 31 and the contact element 32. In addition, the insertion body 31 with the pin 312 protrudes forwards over the contact element 32, whereby mechanical stop damping is achieved between the front end of the running rail 2 and a door or flap of the domestic appliance. In addition to a purely clamping connection between the pin 312 and the contact element 32, it is also possible to thermally deform the pin after insertion through the opening 322 of the contact element 32, so that a form-fit is created.

In the exemplary embodiment shown, a groove 313 is formed on the upper side of the insertion body 31 to secure the stopper 3 in the running rail 2. The front end of the running rail 2 has a punched-out web 24, which is slightly angled downwards. When the stopper 3 is inserted into the front end of the running rail 2, the web 24 engages in the groove 313 in a latching manner and thus secures the stopper 3. The web 24 can be pre-bent so that the stopper 3 can be inserted in a latching manner. It is also conceivable that the web 24 is punched out during the manufacturing process of the running rail 2, but is not angled downwards. The stopper 3 can then be inserted into the front end of the running rail 2, whereupon the web 24 is bent downwards with the stopper 3 already inserted in order to fasten the stopper 3.

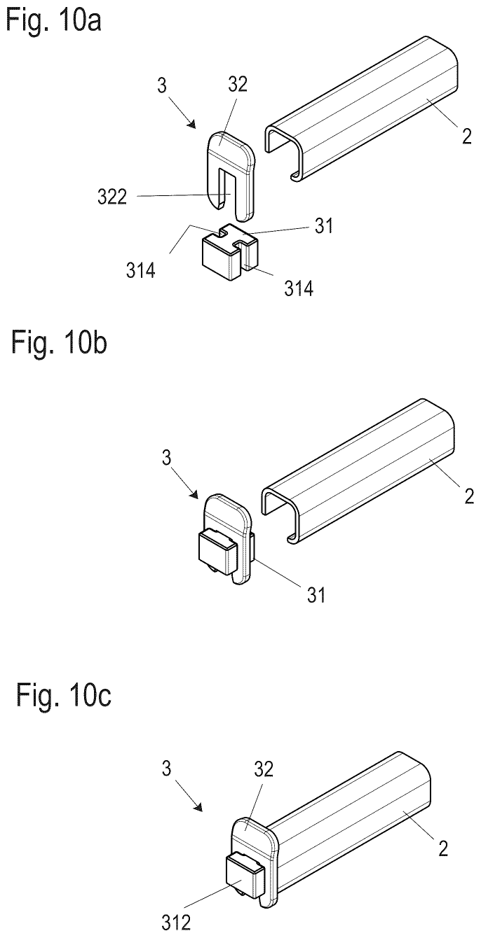

FIGS. 10a-c show a further exemplary embodiment of a two-part stopper 3 in the same way as in FIGS. 9a-c. In contrast to the exemplary embodiment of FIGS. 9a-c, here the insertion body 31 has laterally arranged grooves 314. The contact element 32 again has an opening 322, which in this case is open at the bottom. As can be seen in FIG. 10b, the contact element 32 is inserted with the edges of the opening 322 into the lateral grooves 314 of the insertion body 31 to install the stopper. The resulting stopper 3 is then inserted into the front end of the running rail 2, wherein in the example shown here a purely clamping, frictional connection is provided between the stopper 3 and the running rail 2.

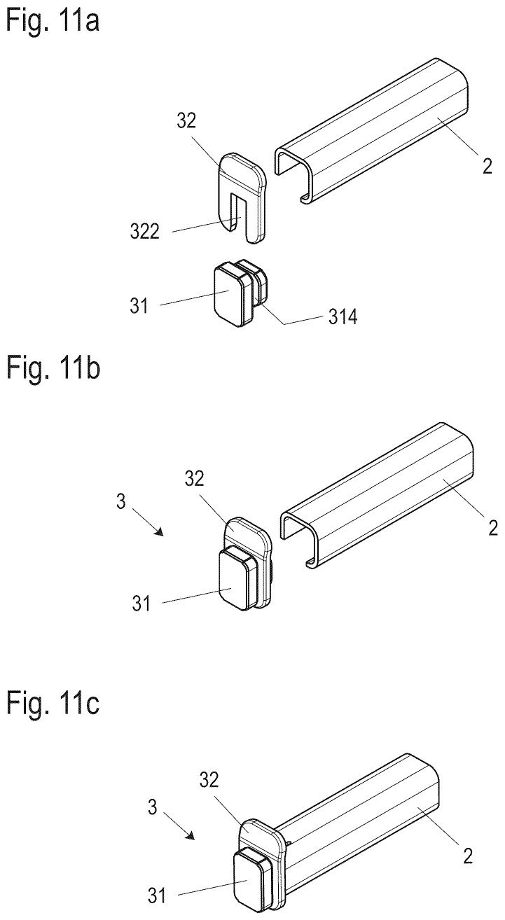

FIGS. 11a-c show a modified embodiment in the same way as FIGS. 10a-c. The basic structure corresponds to that of the exemplary embodiment in FIGS. 10a-c. In contrast to this, the section of the insertion body 31 projecting forwards over the contact element 32 is larger in cross-section than the rear section inserted into the running rail 2.

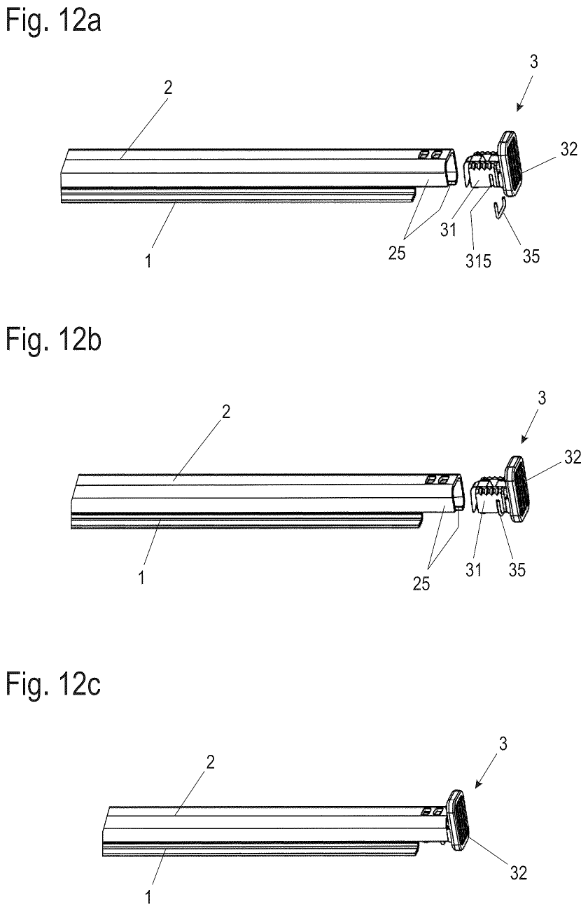

FIGS. 12a to 17c show three further exemplary embodiments of pull-out guides, which are further developments of the fourth exemplary embodiment shown in FIGS. 4a, b. For all three exemplary embodiments, the basic structure of the pull-out guide with cabinet rail 1 and running rail 2 corresponds to the structure of the pull-out guides shown above, to which explicit reference is hereby made.

Only a front section of the pull-out guides, into which a stopper 3 is inserted, is shown. The opposite end section can, for example, be designed as described above with a rear stop for a food carrier, which is also not shown.

All three exemplary embodiments in FIGS. 12a to 17c have in common that a contact element 35 is arranged in or on the stopper 3, which electrically connects end sections 25 of the legs of the U-shaped running rail 2 when the stopper 3 is inserted into the running rail 2.

This is based on the knowledge that microwaves can penetrate through the stopper 3 from the front into the essentially U-shaped running rail if it is made of an insulating material. The microwaves are then transmitted within the running rail 2 by reflection until they hit an obstacle, usually a rolling element cage of the pull-out guide. They emit their energy there, which leads to unnecessary and undesirable heating of the rolling element cage and a reduction in the efficiency of the microwave oven. It has been shown that electrically contacting the end sections 25 of the running rail 2 effectively prevents the microwaves from penetrating into the volume area enclosed by the running rail 2. Contacting that is positioned as close to the edge as possible both in the pull-out direction and in the direction of the free ends of the legs of the U-shaped running rail 2 has proven to be particularly effective.

FIGS. 12a-c and 13a, b show a first exemplary embodiment of such a pull-out rail with stopper 3 with contact element 35.

FIGS. 12a, b each show a section of the cabinet rail 1 and the running rail 2, as well as the stopper 3 before insertion into the front end of the running rail 2. Recesses 315 are made in the insertion body 31 of the stopper 3 at the sides and from below, into which the contact element 35 shown separately in FIG. 12a is inserted. In this exemplary embodiment, the contact element 35 is a U-shaped bent wire section.

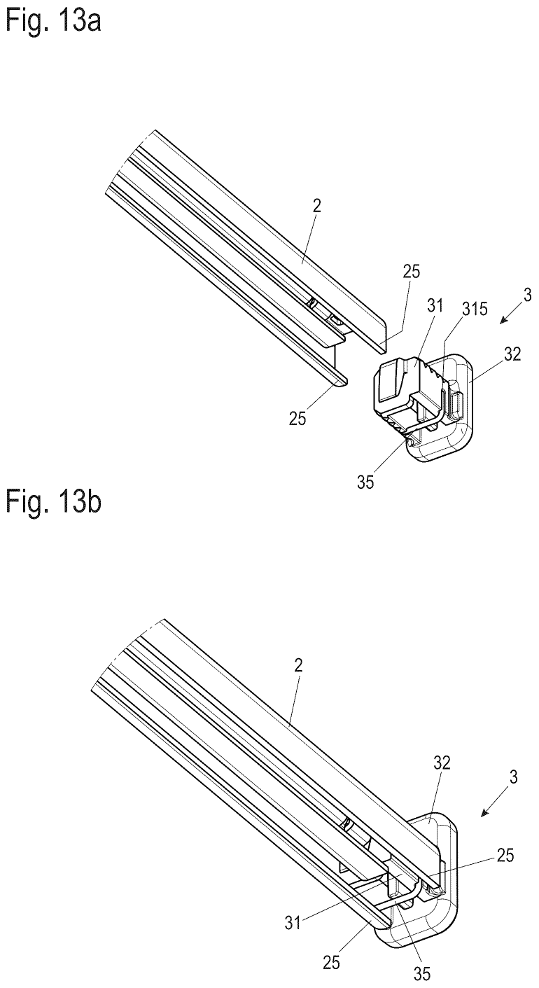

FIGS. 12b and 13a show the contact element 35 inserted into the insertion body 31 from two different angles. Finally, in FIGS. 12c and 13b, the insertion body 31 is inserted into the running rail 2. It can be seen that the contact element 35 connects the free end sections 25 of the legs of the U-shaped running rail 2 to each other. In the end area, the profile of the running rail 2 is therefore electrically closed, providing effective shielding against microwaves. It can be seen that the shielding effect against the penetration of microwaves is just as or at least almost as effective as when the front end of the running rail 2 is completely sealed with an electrically conductive material.

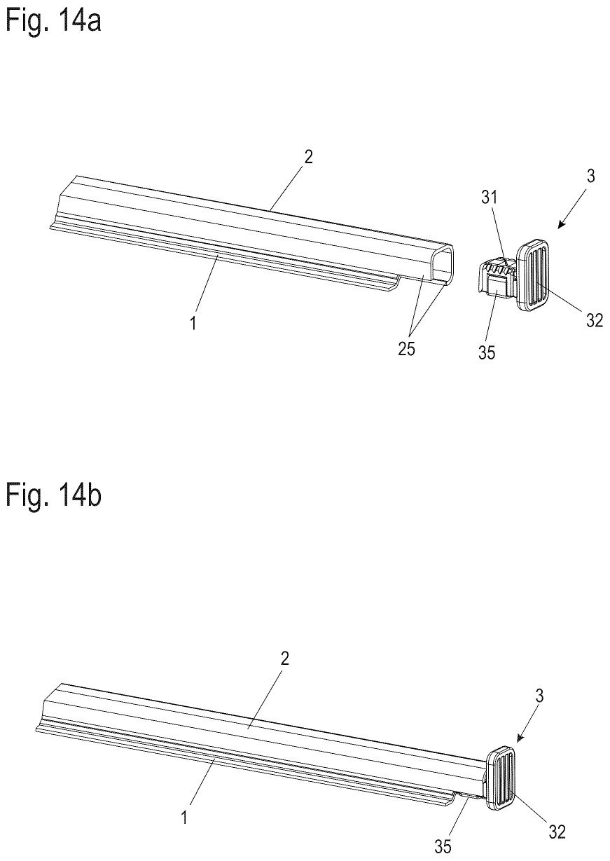

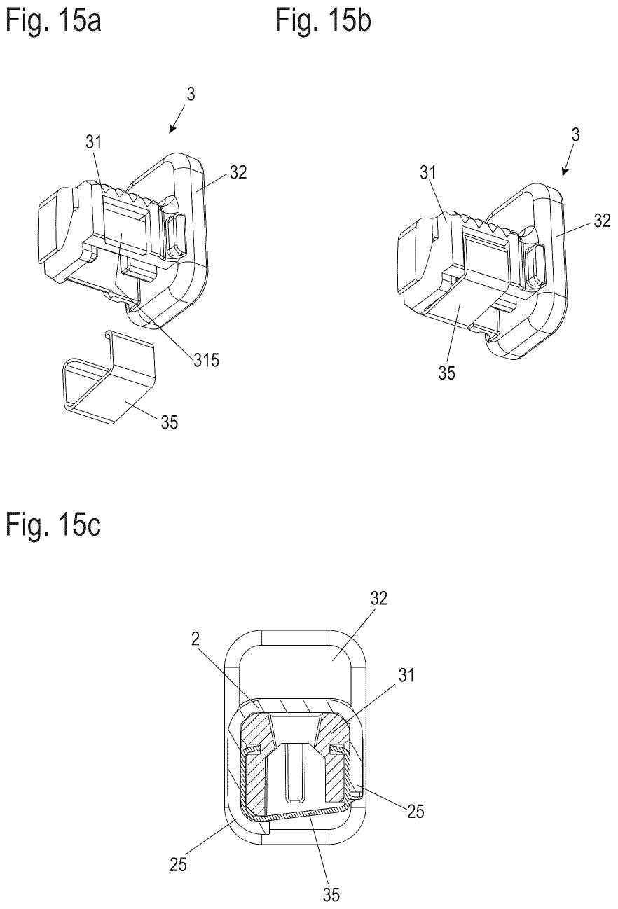

FIGS. 14a, b and 15a-c show a second exemplary embodiment of a pull-out guide with stopper 3 and contact element 35. The representation in FIGS. 14a, b corresponds to that in FIGS. 12b, c. In FIGS. 15a, b, the stopper 3 is shown separately in a spatial representation before the contact element 35 is mounted or with the contact element 35 mounted. FIG. 15c shows a sectional view of the running rail 2 with the stopper 3 inserted.

In contrast to the previously described exemplary embodiment of FIGS. 12a to 13b, the contact element 35 is also a U-shaped bent sheet, not a wire section. Accordingly, the recesses 315 in the insertion body 31 are designed to be wider. In principle, the effect is similar to that of the previously described exemplary embodiment, wherein the greater width of the sheet metal compared to the wire section leads to a more secure contact between the contact element 35 and the end sections 25 of the legs of the running rail 2. Depending on the length of the individual legs of the U-shaped running rail 2, the contact element 35 can deviate from a symmetrical U-shape, as shown in FIG. 15c, in order to connect the end sections 25 of the legs by the shortest route.

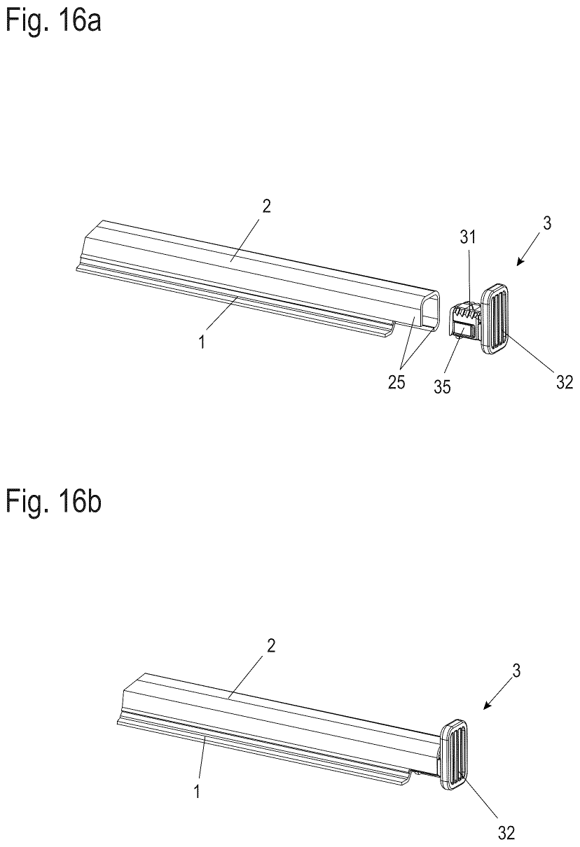

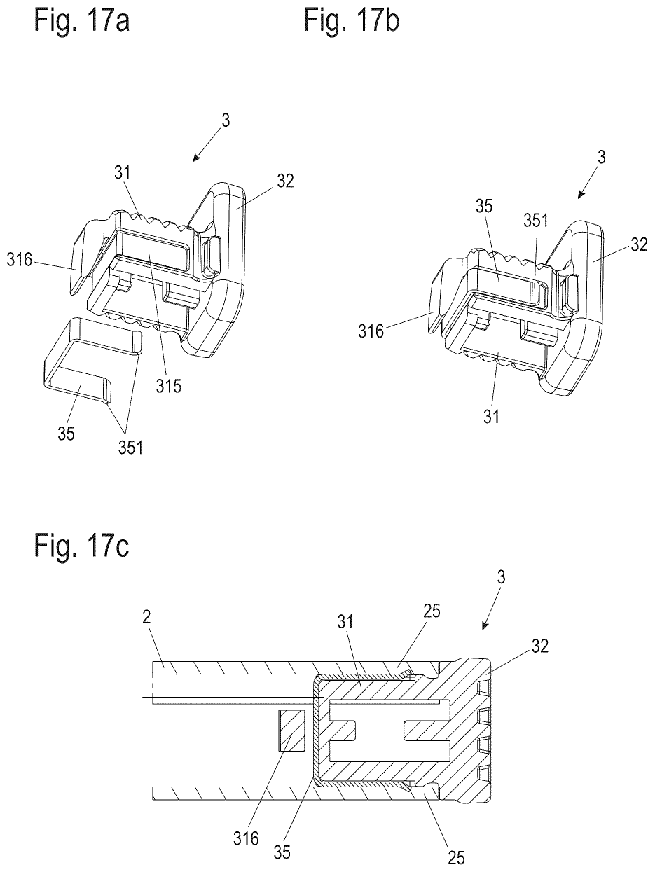

Finally, FIGS. 16a to 17c show a third exemplary embodiment of a pull-out guide with stopper 3 and contact element 35 in a way similar to FIGS. 14a to 15c.

Similar to the previous exemplary embodiment, a U-shaped metal sheet is used as contact element 35. In contrast to the previous exemplary embodiment, the legs of the U-shaped contact element 35 are oriented in the pull-out direction and not perpendicular to it. The recesses 315 on the insertion body 31 are also aligned accordingly.

The advantage here is that even greater clamping forces (which lead to better contact between the contact element 35 and the running rail 2) can be applied without the risk of the contact element 35 being pushed out of the recesses 315 when it is inserted into the running rail 2. In order to achieve a particularly good electrical contact, in this exemplary embodiment the contact element 35 is additionally provided with an angled portion 351 at each of its two free ends towards the outside. The angled portions 351 represent the main contact points to the running rail 2, which are preferably located in the front area of the end section 25. A stop tab 316 integrated in the rear area of the stopper 3 prevents the pre-assembled contact element 35 from falling out of the recess 315 during assembly and also prevents other guide elements, such as cabinet rail 1 or center rail, from making contact with the contact element 35.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 Cabinet rail
11 Mounting clamp
2 Running rail
21 Recess
211 Web
22 Hole
23 Stop bolt
24 Web
25 End section
3 Stopper
31 Insertion body
311 Elevation
312 Pin
313 Groove
314 Lateral groove
315 Recess
316 Stop tab
32 Contact element
321 Damping element
322 Opening
33 Support section
331 Longitudinal web
332 Guide pin
34 Base body
341 Projection
35 Contact element
351 Angled portion
4 Stop element
41 Mounting means
42 Stop
43 Support section
431 Longitudinal web
44 Damping cap
6 Baking tray
61 Edge
62 Aperture
63 Edge

1-22. (canceled)

23. A pull-out guide for a domestic appliance with microwave cooking function, the pull-out guide comprising:
a cabinet rail;
a metallic running rail movable relative to the cabinet rail and configured so that a food carrier is depositable on the metallic running rail; and
a stopper arranged in a front region of the running rail as seen in a pull-out direction, wherein the stopper has a contact element for the food carrier, wherein the contact element projects forwards and upwards over the metallic running rail, and wherein the stopper is at least partially made from an electrically insulating material.

24. The pull-out guide of claim 23, wherein at least the contact element is made of the electrically insulating material.

25. The pull-out guide of claim 23, wherein the electrically insulating material is also thermally insulating or shock-absorbing.

26. The pull-out guide of claim 23, wherein the electrically insulating material is a ceramic, a high-temperature-resistant thermoplastic, an elastomer, or a thermoset.

27. The pull-out guide of claim 23, wherein the stopper has an insertion body inserted into a front end of the metallic running rail.

28. The pull-out guide of claim 27, wherein the insertion body is clamped or latched to the metallic running rail.

29. The pull-out guide of claim 27, wherein a section of the running rail is formed in the front region to fasten the insertion body in a form-fitting or force-fitting manner.

30. The pull-out guide of claim 29, wherein, wherein the metallic running rail has a punched-out web.

31. The pull-out guide of claim 23, wherein the stopper has a C-shaped base body plugged onto the metallic running rail.

32. The pull-out guide of claim 31, wherein the C-shaped base body is clamped or latched to the metallic running rail.

33. The pull-out guide of claim 31, wherein the base body has a projection engaging in a hole or recess in the metallic running rail.

34. The pull-out guide of claim 23, wherein the stopper has a support section for the food carrier, wherein the support section is aligned parallel to the pull-out direction and projects upwards over the metallic running rail.

35. The pull-out guide of claim 34, wherein the support section of the stopper has longitudinal webs on which the food carrier is restable.

36. The pull-out guide of claim 34, further comprising:
an upwardly projecting guide pin for the food carrier arranged in a region of the support section of the stopper.

37. The pull-out guide of claim 23, wherein the stopper is formed in one piece.

38. The pull-out guide of claim 27, wherein the stopper is comprised of at least in two parts, wherein the contact element is not integrally formed with the insertion body, wherein the contact element is made of a different material than the insertion body, and wherein the insertion body is made of the electrically insulating material.

39. The pull-out guide of claim 31, wherein the stopper is comprised of at least in two parts, wherein the contact element is not integrally formed with the C-shaped base body, wherein the contact element is made of a different material than the C-shaped base body, and wherein the C-shaped base body is made of the electrically insulating material.

40. The pull-out guide of claim 23 wherein the metallic running rail has a U-shaped profile with two legs, wherein a further contact element is arranged on or in the stopper, wherein the further contact element electrically contacts two end sections of the legs of the metallic running rail with each other.

41. The pull-out guide of claim 23, further comprising:
a stop element mounted on the metallic running rail in a rear region as seen in the pull-out direction, wherein the stop element has a stop for the food carrier projecting upwards over the metallic running rail.

42. The pull-out guide of claim 41, wherein the stop element has a further support section for the food carrier, wherein the further support section is aligned parallel to the pull-out direction and projects upwards over the metallic running rail.

43. A domestic appliance with microwave cooking function, comprising:
at least one pull-out guide configured to accommodate a food carrier, wherein the at least one pull-out guide comprises
a cabinet rail;
a metallic running rail movable relative to the cabinet rail and configured so that the food carrier is depositable on the metallic running rail; and
a stopper arranged in a front region of the running rail as seen in a pull-out direction, wherein the stopper has a contact element for the food carrier, wherein the contact element projects forwards and upwards over the metallic running rail, and wherein the stopper is at least partially made from an electrically insulating material.
